(19) United States
(12) Patent Application Publication
(10) Pub. No.: US 2003/0236840 A1
(43) Pub. Date: Dec. 25, 2003

(54) ELECTRONIC-MAIL PROCESSING METHOD AND APPARATUS

(76) Inventor: SHIGEKI HIROOKA, KAWASAKI-SHI (JP)

Correspondence Address: FITZPATRICK CELLA HARPER & SCINTO, 30 ROCKEFELLER PLAZA, NEW YORK, NY, 10112, US

(21) Appl. No.: 09/337,546

(22) Filed: Jun. 22, 1999

(30) Foreign Application Priority Data
Jun. 30, 1998 (JP) 184717/1998

(51) Int. Cl. G06F 17/21

(52) U.S. Cl. 709/206

(57) ABSTRACT

According to the present invention, e-mails are selectively preserved. Hence, it is possible to efficiently utilize a memory, since only data of a type supported by e-mail application software is selectively preserved. Since the type of data of the received e-mail is automatically determined, it is unnecessary to add particular data for controlling handling of the e-mail, operability is improved, and a complicated data structure is not necessary. Moreover, since appropriate determination and processing are performed for each of a plurality of data contained in the received e-mail, it is possible to prevent abandonment of all data based on the first data.

### BACKGROUND OF THE INVENTION

1. Field of the Invention

The present invention relates to a processing method and apparatus when an unprocessed electronic mail (“e-mail”) is read, a method and apparatus for processing an e-mail transmitted from another machine via a communication network, and a method and apparatus for processing received e-mail including at least one type of data from among various types of data.

2. Description of the Related Art

In e-mail receiving processing in conventional e-mail application software, it is determined whether or not the e-mail is to be received only in accordance with the size of the e-mail, and all data included in a received e-mail is preserved even if there is no means for utilizing the received data.

In this conventional approach, however, even a received e-mail including data which cannot be displayed or reproduced at the reception side is preserved, resulting in the useless, although temporary, occupation, of a storage region.

In the worst case, the storage region is uselessly occupied for storing an e-mail including data which cannot be utilized, resulting in the incapability of receiving necessary mail.

### SUMMARY OF THE INVENTION

It is an object of the present invention to provide an e-mail receiving method and apparatus which can prevent use-less occupation of a storage region by not preserving the e-mail whenever necessary.

It is another object of the present invention to assuredly select data which can be obtained by the operator in receiving an e-m ail in which various types of data can be contained.

According to one aspect of the present invention, an e-mail processing method includes the steps of identifying a type of data of a received e-mail, and determining whether not the received e-mail is to be utilized in accordance with the identified type of data.

According to another aspect of the present invention, an e-mail processing apparatus includes type identification means for identifying a type of data of a received e-mail, and determination means for determining whether not the received e-mail is to be utilized in accordance with the identified type of data.

According to still another aspect of the present invention, a storage medium, capable of being read by a computer, stores a control program for identifying a type of data of a received e-mail, and a control program for determining whether not the received e-mail is to be utilized in accordance with the identified type of data.

The foregoing and other objects, advantages and features of the present invention will become more apparent from the following desription of the preferred embodiment taken in conjunction with the accompanying drawings.

### BRIEF DESCRIPTION OF THE DRAWINGS

FIG. 1 is a flowchart illustrating data selection processing according to an embodiment of the present invention;

FIG. 2 is a flowchart illustrating another data selection processing according to the embodiment;

FIG. 3 is a flowchart illustrating processing for determining whether or not data is to be utilized;

FIG. 4 is a flowchart illustrating processing for acquiring the type of data;

FIG. 5 is a block diagram illustrating a data structure for holding types of data to be utilized;

FIG. 6 is a diagram illustrating the structure of an e-mail when a part of the data is read and then abandoned;

FIG. 7 is a block diagram illustrating the configuration of a system to which the present invention can be applied;

FIG. 8 is a diagram illustrating an example of the structure of an e-mail;

FIG. 9 is a diagram illustrating the external appearance of a portable information terminal according to the embodiment; and

FIG. 10 is a block diagram illustrating the configuration of the portable information terminal shown in FIG. 9.

### DESCRIPTION OF THE PREFERRED EMBODIMENT

A preferred embodiment of the present invention will now be described in detail with reference to the drawings.

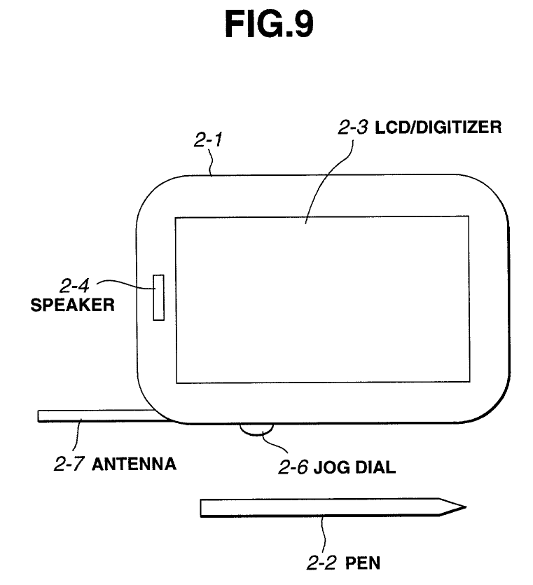

FIG. 9 is a diagram illustrating the external appearance of a portable information terminal, serving as an apparatus according to the embodiment.

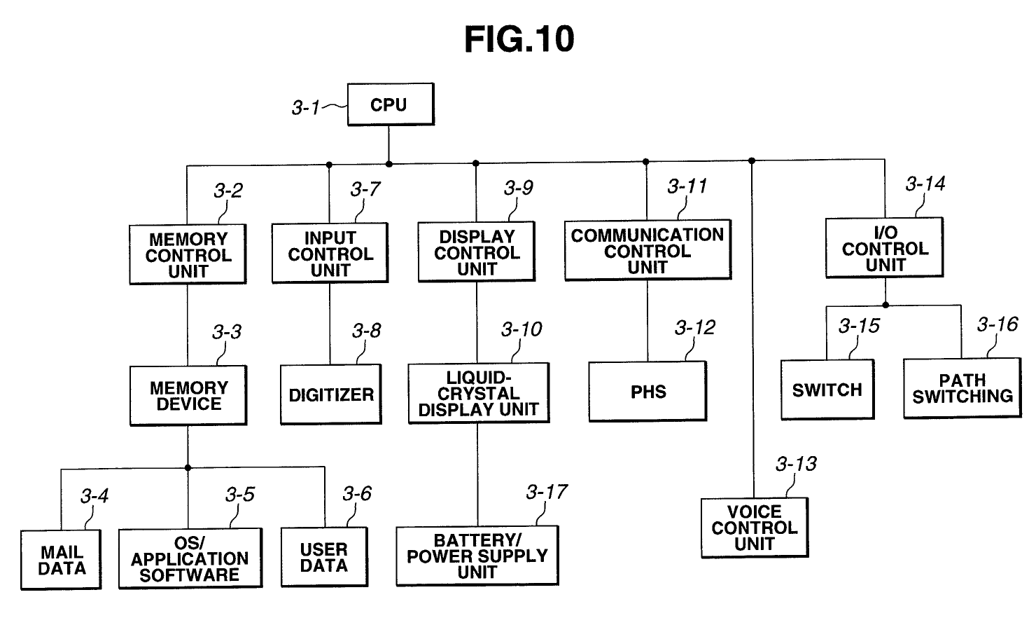

This apparatus includes a main body 2-1 and a pen 2-2 for writing data. In the main body 2-1, an input panel 2-3 is used for inputting/outputting data, in which the display picture surface of a liquid-crystal display unit 3-10 and an input region of a digitizer 3-8 (see FIG. 10) are super-posed. A speaker 2-4 outputs voice during voice communication, and also outputs an alarm or a message for attracting the operator's attention. A jog dial 2-6 is generally used for various purposes, such as display of a menu, moving of an item to be selected, and the like. In the apparatus of the embodiment, the jog dial 206 is also used as a switch 3-15 (see FIG. 10) for instructing confirmation of the selection of an item selected on the display picture surface by rotating the jog dial 2-6. An antenna 2-7 is used for a PHS (Personal Handyphone System) 3-12 (see FIG. 10).

FIG. 10 is a block diagram illustrating the configuration of the portable information terminal of the embodiment. In FIG. 10, a CPU (central processing unit) 3-1 controls the entire apparatus, and comprises, for example, a 32-bit RISC (reduced instruction set computer) device, and executes various processes (to be described later) in accordance with control programs stored in a memory device 3-3. A memory control unit 3-2 selects an appropriate device in accordance with a command from the CPU 3-1, and also performs a refreshing or backup operation. The memory device 3-3 comprises, for example, an SRAM (static random access memory), a DRAM (dynamic random access memory), a ROM (read-only memory inclusive of a flash memory) or the like, and stores data and programs. Control programs to be used by the CPU 3-1 for executing various processes, such as the ones shown in the following flowcharts, according to the embodiment are also stored in the memory device 3-3. The stored contents are, for example, mail data 3-4 including received mail to be temporarily held or selected and preserved mail, OS (operation system)/application software 3-5, and user data 3-6 input by the user. An input control unit 3-7 controls the digitizer 3-8 to which data can be input using the pen 2-2. A display control unit 3-9 sequentially reads display data from a VRAM (video random access memory, not shown), and transmits data and a timing signal to the liquid-crystal display unit 3-10. A communication control unit 3-11 connects the PHS 3-12 to the main body of the portable information terminal, and may comprise, for example, a serial communication interface, such as RS232C or the like. The communication control unit 3-11 also controls transmission and reception of data with other devices connectable via a public telephone network or a LAN (local area network). A voice control unit 3-13 performs processing relating to sound or voice, such as an alarm output, message output or the like. An I/O (input/output) control unit 3-14 monitors the switch 3-15, and performs path switching 3-16 according to software. A battery/power supply unit 3-17 controls a battery and a power supply for driving the portable information terminal, and includes a DC-to-DC converter and a charging control unit.

A specific example will now be described.

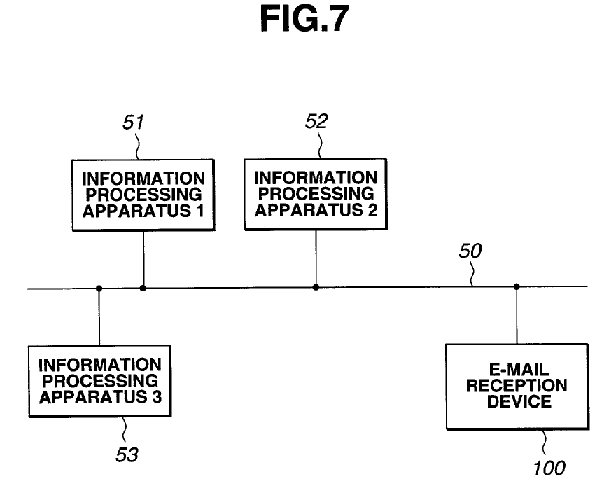

FIG. 7 illustrates an example of the configuration of a system to which the present invention can be applied. In FIG. 7, an e-mail reception device 100 may be a device such as the one shown in FIGS. 9 and 10.

The e-mail reception device 100 for receiving e-mail, and information processing apparatuses 51-53, such as host computers or the like, for transmitting e-mail, are connected to a network 50, comprising a public telephone network and a LAN. The configuration of the system is not limited to this configuration. Any other system, such as a system having the function of transmitting and receiving data between terminals using wireless devices, may also be adopted.

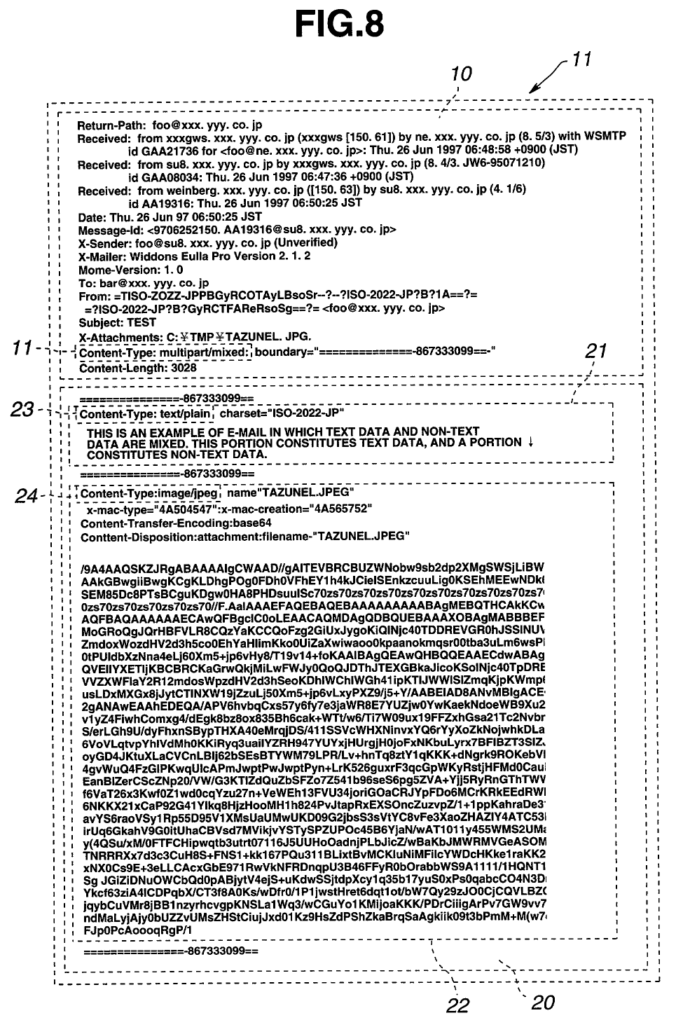

FIG. 8 illustrates an example of the configuration of an e-mail.

In FIG. 8, an e-mail 1 includes a header 10 and a text 20.

In the header 10, “the type of data of the text” 11 is described in a specific field. By analyzing the specific field, the type of data of the text 11 can be determined.

In this example, “multipart/mixed” is described as the type of data of the text 11.

The text 20 incudes text data 21 and image data 22. In this case, “the type of data” 23 indicates that the contents of data correspond to a text, and is described in a specific field. Within the image data 22, “the type of data” 24 indicates that the contents of data correspond to an image, and is also described in a specific field.

In this example, “text/plain” is described as “the type of data” 23, and “image/ipeg” is described as “the type of data” 24.

When the text 20 includes a plurality of data as in the above-described case, each data comprises a header and the contents of the data (text), and the type of each data is described in a specific field of the header of the data. Accordingly, by analyzing the specific field within the text 20, it is possible to obtain the type of data for which the specific field is included in the text 20.

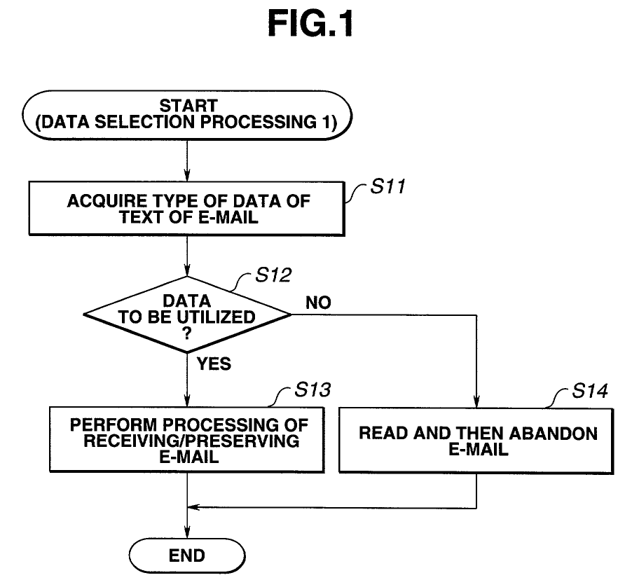

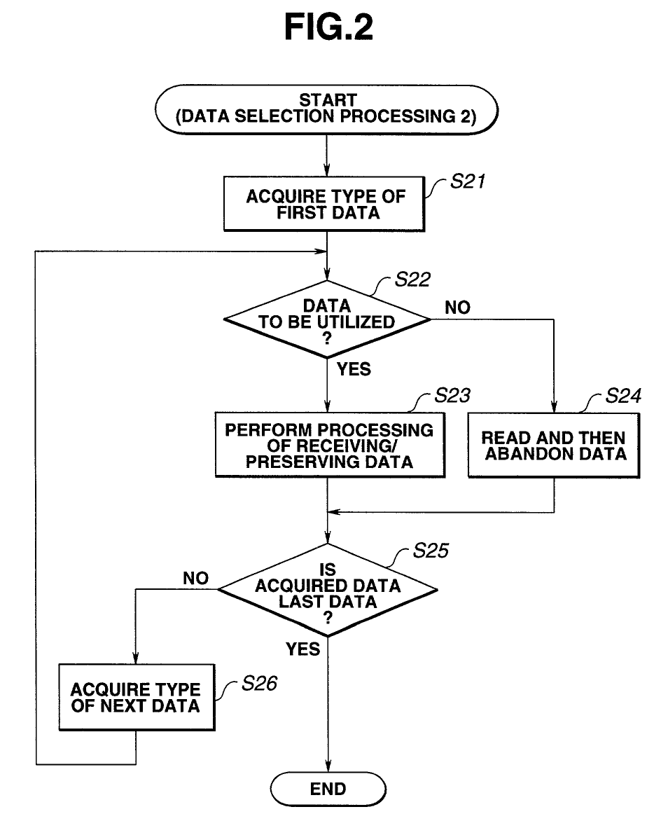

FIGS. 1 and 2 are flowcharts for selecting received mail data to be preserved by determining whether or not the received mail can be utilized. Each of the flowcharts is executed when receiving an e-mail from one of the information processing apparatuses 51-53 under the control of the communication control unit 3-11. The received e-mail is temporarily stored in the memory device 3-3 until the selection processing shown in FIG. 1 or 2 is completed.

FIG. 1 illustrates a first example of data selection processing.

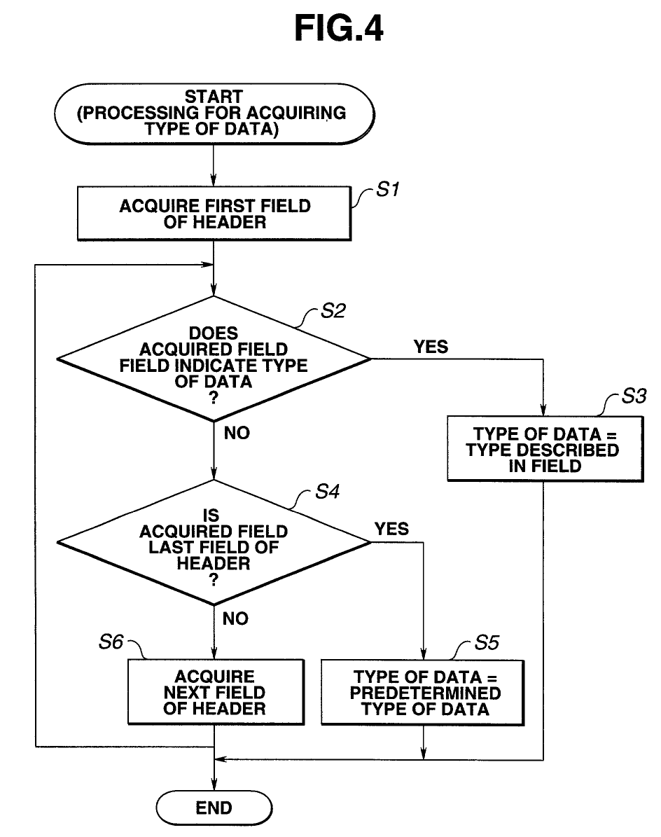

In step S11, the type of data of the text 20 within the e-mail 1 is acquired. The details of the processing in step S11 are shown in the flowchart of FIG. 4 (to be described later).

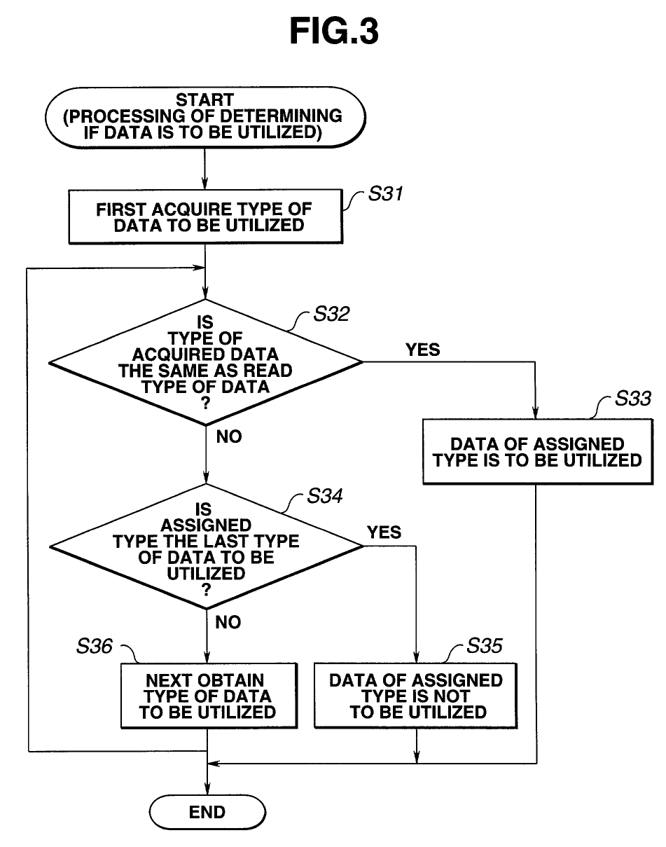

In step S12, it is determined if the data within the e-mail 1 is to be utilized from the type of data acquired in step S1. If the result of the determination in step S12 is affirmative, the process proceeds to step S13. If the result of the determination in step S12 is negative, the process proceeds to step S14. The details of the processing in step S12 are shown in the flowchart of FIG. 3 (to be described later).

In step S13, the reception of the e-mail 1 is continued because it has been determined in step S12 that the data is to be utilized, and processing for preserving the e-mail 1 as data to remain, even after turning off the electric power supply, in the form of a mail file in the memory device 3-3 is performed.

In step S14, processing for reading and then abandoning the e-mail 1 is performed because it has been determined in step S12 that the data is not to be utilized. This processing is performed by deleting the data of the e-mail 1 temporarily stored in the memory device 3-3, or performing control so that the preserving processing in step S13 is not executed.

A description will now be provided of the details of the processing for acquiring the type of data in step S11 with reference to the flowchart shown in FIG. 4.

In step S1, the first field of the header 10 is acquired.

In step S2, it is determined if the acquired field is a field indicating the type of data. The determination in step S2 is realized by analyzing codes which are sequentially in-put and identifying whether or not the input code string coincides with a predetermined code string representing the field indicating the type of data. In the example shown in FIG. 8, when a code representing a character string “Content-Type” is identified, a line including these characters is determined to be the field indicating the type of data. If the result of the determination in step S2 is affirmative, the process proceeds to step S3. If the result of the determination in step S2 is negative, the process proceeds to step S4.

In step S3, the type of data described in the field is made the type of the current data and is stored in the memory device 3-3, and the processing for acquiring the type of data is terminated.

In step S4, it is determined if the field determined in step S2 is the last field in the header 10. If the result of the determination in step S4 is affirmative, the process proceeds to step S5. If the result of the determination in step S4 is negative, the process proceeds to step S6.

In step S5, a predetermined type of data stored in advance in the memory device 3-3 is determined to be the type of desired data and is stored in the memory device 3-3, and the processing for acquiring the type of data is terminated. The storage of information relating to the type of data in step S3 or S5 is performed so as to correspond to identification information for the header or the e-mail to be processed at that time. Alternatively, an area for storing the type of data currently being processed may be provided in advance in the memory device 3-3, and information relating to the type of data may be overwritten in the storage area every time the processing of step S3 or S5 is executed.

In step S6, the next field of the header 10 is acquired, and the process then returns to the processing of step S2. Thus, it is possible to acquire the type of data described in the header 10.

The type of data stored in the memory device 3-3 in step S3 or S5 is the type of data of the text of the e-mail, and is to be determined in step S12.

Next, a second example of e-mail data selection processing will be described with reference to the flowchart shown in FIG. 2. When the type of data acquired in step S11 shown in FIG. 1 is “multipart/mixed” or the like, i.e., when the concerned e-mail has a hierarchical structure having a text comprising a plurality of data, the processing of the flowchart of FIG. 2 is started instead of proceeding to step S12. In this processing, each data is selected by determining the type of the data. Accordingly, in the flowchart shown in FIG. 2, in step S21, the first data from among a plurality of data contained in the text of the received e-mail data is read, and reading (step S26) and selection processing (steps S22-S24) of data are repeated until it is determined in step S25 that the selection processing has been completed to the last data contained in the text of the received e-mail data.

Each step of the processing will now be described.

In step S21, the type of the first data within the e-mail 1 is acquired. This processing can be performed in accordance with the above-described acquisition processing shown in FIG. 4. In the flowchart shown in FIG. 4, a code representing the type of data within the header of the e-mail is retrieved. In step S21, by executing the processing of steps S1-S6 for read data (a part of the text), the type of the data can be acquired.

In step S22, it is determined if the data within the e-mail 1 is to be utilized based on the acquired type of the data. If the result of the determination in step S22 is affirmative, the process proceeds to step S23. If the result of the determination in step S22 is negative, the process proceeds to step S24.

In step S23, processing for continuing to receive the electric mail and preserving the contents of data of the e-mail 1 is performed because the data is to be utilized.

In step S24, processing for reading and then abandoning data within the e-mail 1 is peformed because the data is not to be utilized.

In step S25, it is determined if the acquired data is the last data within the e-mail 1. If the result of the determination in step S25 is affirmative, the process is terminated. If the result of the determination in step S25 is negative, the process proceeds to step S26.

In step S26, the next data is acquired because the immediately previously acquired data is not the last data, and the process returns to step S22. The processing in step S26 is the same as the processing in step S21.

The flowchart shown in FIG. 3 illustrates the details of the processing for determining if the data is to be utilized in step S12 shown in FIG. 1 or step S22 shown in FIG. 2. A description will now be provided of the flowchart shown in FIG. 3.

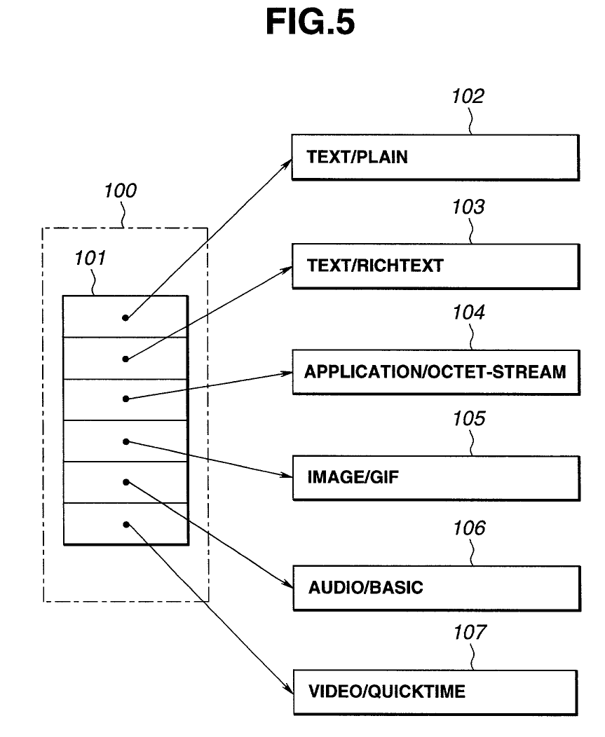

In step S31, the first type of utilizable data is read from the types of utilizable data held in advance in the memory device 3-3. FIG. 5 illustrates the structure of a unit for storing the types of utilizable data stored in the memory 3-3. The structure shown in FIG. 5 will be described later.

In step S32, it is determined if the type of data stored in the memory device 3-3 in step S3 or S5 is the same as the read type of utilizable data, i.e., if the type of data to be processed coincides with a type of utilizable data registered in advance.

If the result of the determination in step S32 is affirmative, the process proceeds to step S33. If the result of the determination in step S32 is negative, the process proceeds to step S34.

In step S33, it is determined that the data being processed can be utilized because it has been determined that the type of the data is the same as a registered type, and the processing of determining if the data can be utilized is terminated by raising a flag indicating utilizability of data.

In step S34, it is determined if the assigned type of data is the last type of utilizable data, i.e., if matching of the data to determine whether or not the data can be utilized with all types of utilizable data registered in the memory device 3-3 in advance has been completed, because it has been determined that the type of the data is different from the last registered type. If the result of the determination in step S34 is affirmative, the process proceeds to step S35. If the result of the determination in step S34 is negative, the process proceeds to step S36.

In step S35, it is determined that the data being processed cannot be utilized because it does not match the last type of registered utlizable data. Hence, a flag indicating nonutilizability of data is raised, and the process is terminated.

In step S36, the next type of utilizable data is read from the memory device 3-3 because the assigned type of data is not the last type of registered utilizable data, and the process returns to the processing of step S32. Thus, it is possible to determine if data can be utilized.

FIG. 5 illustrates an example of a data structure for holding the types of utilizable data.

Within the memory device 3-3, a storage region 101 for storing the types of utilizable data is provided.

Reference numerals 102-107 represent the types of utilizable data stored in the storage region 101.

In this case, the data structure for holding the types of utilizable data is provided as an arrangement of pointers to the storage region 101 for storing the types of utilizable data 102-107 (such as “image/gif” 105 indicating that the data is image data in a GIF (Graphics Interchange Format), or the like). By sequentially tracing this arrangement in steps S31 and S36, the types of utilizable data stored in the storage region 101 can be sequentially obtained.

The types of data which can be displayed or reproduced by e-mail application software used in the apparatus may be registered in e-mail application software as the types of utilizable data, or the system may be configured so that the types of data which can be displayed or reproduced by any means, such as application software or the like, other than e-mail application software can be registered by the application software or the user.

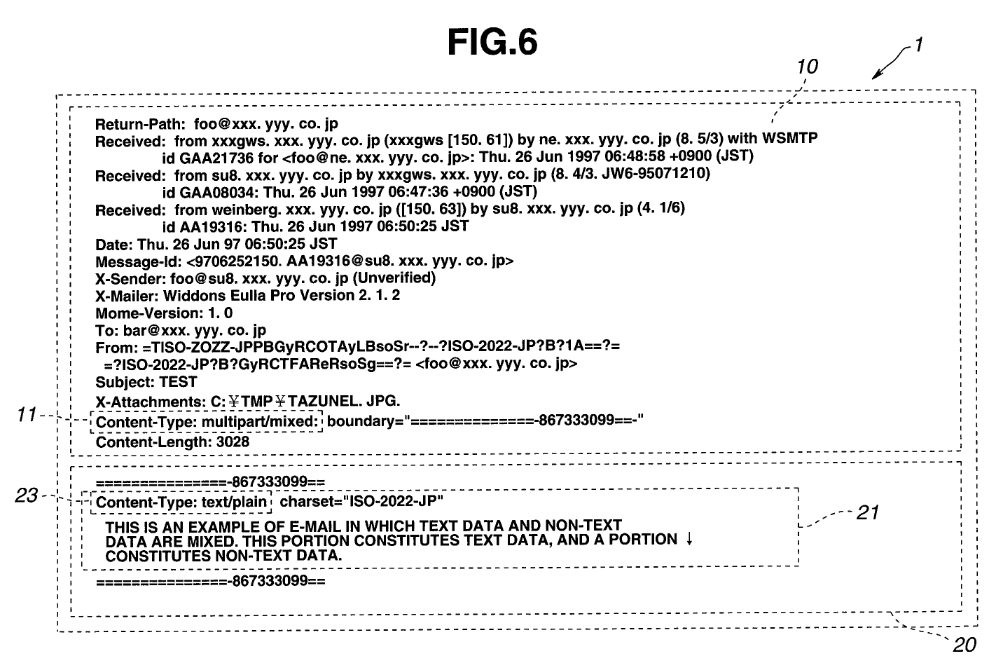

FIG. 6 illustrates an example of the e-mail 1 when a portion of data not to be utilized is read and then abandoned.

When the image data 22 in the e-mail 1 shown in FIG. 8 is data which cannot be utilized, the e-mail 1 is preserved in a state in which that portion of the image data 22 is read and then abandoned, as shown in FIG. 6. In this case, only the text data 21 remains present in the text 20 of the e-mail 1. It is thereby possible to prevent useless occupation of the storage region by the amount of image data which cannot be utilized. The processing of reading and then abandoning the data portion which is not utilized corresponds to the above-described processing of step S24 shown in FIG. 2.

Although the processing of reading and then abandoning a portion of data which is not utilized within the e-mail 1 has been described, the present invention is not limited to such an approach. For example, reception and/or preservation of the e-mail 1 may be interrupted when the type of the received data indicates data not to be utilized.

Although in this embodiment, control programs for the flowcharts shown in FIGS. 1-4 are stored in a storage device, such as a ROM or the like, within the e-mail reception apparatus 100, these programs may be stored in a separately provided storage medium, such as a floppy disk or the like.

In the first data selection processing, when the type of data in the text 20 of the e-mail 1 indicates data which cannot be utilized, the e-mail 1 is read and then abandoned. However, the user may be notified of the fact that the data cannot be utilized by any means, such as a display on a display picture surface, or the like, before reading and then abandoning the data, and the user may select whether the data is to be read and then abandoned, or to be preserved.

In the second data selection processing of FIG. 2, when the type of data of a part of the text 20 of the e-mail 1 indicates data which cannot be utilized, that part of the e-mail is read and then abandoned. However, the user may be notified of the fact that the data cannot be utilized by displaying the fact on a display picture surface, inserting data indicating the presence of data which cannot be utilized instead of the data read and then abandoned, or using means, such as a display on a display picture surface, or the like, before reading and then abandoning the data, and the user may then select whether the data is to be read and then abandoned, or to be preserved.

In the processing of acquiring the type of data, the type of data is acquired based on a field describing the type of data in the text 20 of the e-mail 1 or in the header of data included in the text 20 of the e-mail 1. However, the type of data may be acquired by analyzing the contents of the data, for example, by acquiring information relating to the image format contained in the header of the image data, or by determining the type of data from the characteristic configuration of the data.

In the processing of acquiring the type of data, when a field indicating the type of data is not present in the text of the e-mail, nor in the header of data contained in the text of the e-mail, a predetermined type of data is assumed to be the type of the data. Alternately, however, when the type of the data cannot be acquired, all such data may be determined as data which cannot be utilized.

The present invention may be applied to a system comprising a plurality of apparatuses, or to an apparatus comprising a single unit. The present invention may, of course, be applied to a case in which the objects of the invention are achieved by supplying a system or an apparatus with a program. In this case, the system or the apparatus can be provided with the effects of the present invention by reading a program represented by software for achieving the present invention stored in a storage medium into the system or the apparatus.

The individual components shown in outline or designated by blocks in the drawings are all well known in the e-mail processing method and apparatus arts and their specific construction and operation are not critical to the operation or the best mode for carrying out the invention.

While the present invention has been described with respect to what is presently considered to be the preferred embodiment, it is to be understood that the invention is not limited to the disclosed embodiment. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An e-mail processing method comprising the steps of:
identifying a type of data of a received e-mail; and
determining whether not the received e-mail is to be utilized in accordance with the identified type of data.

2. A method according to claim 1, further comprising the steps of:
registering an arbitrary type of data in advance; and
determining that the e-mail is to be utilized when the identified type of data coincides with the registered type of data.

3. A method according to claim 1, wherein, when it has been determined that the e-mail is to be utilized, the e-mail is preserved as a file.

4. A method according to claim 1, wherein, when it has been determined that the e-mail is not to be utilized, the e-mail is not preserved.

5. A method according to claim 1, wherein, when it has been determined that the e-mail is not to be utilized, the e-mail is read and then abandoned.

6. A method according to claim 5, wherein a presence of an e-mail to be read and then abandoned is notified for ex-eternal use.

7. A method according to claim 1, wherein, when it has been determined that the e-mail is not to be utilized, reception of the e-mail is interrupted.

8. A method according to claim 1, wherein a presence of an e-mail which has been determined not to be utilized is notified for external use.

9. A method according to claim 1, wherein identification of the type of data is performed for each of a plurality of data contained in the e-mail.

10. A method according to claim 1, wherein when it has been determined that the e-mail is not to be utilized, a subsequent process is selectable from among a plurality of predetermined processes.

11. A method according to claim 1, wherein the type of data comprises a text.

12. A method according to claim 1, wherein the type of data comprises an image.

13. A method according to claim 1, wherein the identification of the type of data is performed by analyzing the received e-mail.

14. A method according to claim 1, wherein a character string is retrieved from the received e-mail, and the type of data is identified according to a reference character string specified based on a position in the received e-mail where the retrieved character string is present.

15. An e-mail processing apparatus comprising:
type identification means for identifying a type of data of a received e-mail; and
determination means for determining whether not the received e-mail is to be utilized in accordance with the identified type of data.

16. An apparatus according to claim 15, further comprising storage means for storing an arbitrary type of data, wherein said determination means determines that the e-mail is to be utilized when the identified type of data coincides with the stored type of data.

17. An apparatus according to claim 15, further comprising preservation control means for preserving the e-mail as a file when said determination means has been determined that the e-mail is to be utilized.

18. An apparatus according to claim 17, wherein, when said determination means has determined that the e-mail is not to be utilized, said preservation control means performs control so as not to preserve the e-mail.

19. An apparatus according to claim 15, further comprising control means for performing control so as to read and then abandon the e-mail when said determination means has determined that the e-mail is not to be utilized.

20. An apparatus according to claim 19, further comprising notification means for notifying, for external use, a presence of an e-mail to be read and then abandoned.

21. An apparatus according to claim 15, further comprising communication control means for performing control so as to interrupt reception of the e-mail when said determination means has determined that the e-mail is not to be utilized.

22. An apparatus according to claim 15, further comprising notification means for notifying, for external use, a presence of an e-mail which has been determined not to be utilized by said determination means.

23. An apparatus according to claim 15, wherein said type identification means performs identification of the type of data for each of a plurality of data contained in the e-mail.

24. An apparatus according to claim 15, further comprising selection means for causing a subsequent process to be selectable from among a plurality of predetermined processes when said determination means has determined that the e-mail is not to be utilized.

25. An apparatus according to claim 15, wherein the type of data comprises a text.

26. An apparatus according to claim 15, wherein the type of data comprises an image.

27. An apparatus according to claim 15, wherein said type identification means identifies the type of data by analyzing the received e-mail.

28. An apparatus according to claim 15, wherein said type identification means retrieves a character string from the received e-mail, and identifies the type of data according to a reference character string specified based on a position in the received e-mail where the retrieved character string is present.

29. A storage medium, capable of being read by a computer, storing control software, said control software comprising:
a control program for identifying a type of data of a received e-mail; and
a control program for determining whether not the received e-mail is to be utilized in accordance with the identified type of data.

30. A storage medium according to claim 29, wherein said control software further comprises:
a control program for reading a type of data which has been registered in advance in a memory; and
a control program for dertermining that the e-mail is to be utilized when the identified type of data coincides with the read type of data.

31. A storage medium according to claim 29, wherein said control software further comprises a control program for preserving the e-mail as a file when it has been determined that the e-mail is to be utilized.

32. A storage medium according to claim 29, wherein said control software further comprises a control program for performing control so as not to preserve the e-mail when it has been determined that the e-mail is not to be utilized.

33. A storage medium according to claim 29, wherein said control software further comprises a control program for performing control so as to read and then abandon the e-mail when it has been determined that the e-mail is not to be utilized.

34. A storage medium according to claim 33, wherein said control software further comprises a control program for notifying, for external use, a presence of the e-mail to be read and then abandoned.

35. A storage medium according to claim 29, wherein said control software further comprises a control program for interrupting reception of the e-mail when it has been determined that the e-mail is not to be utilized.

36. A storage medium according to claim 29, wherein said control software further comprises a control program for notifying, for external use, a presence of the e-mail which has been determined not to be utilized.

37. A storage medium according to claim 29, wherein said control software further comprises a control program for performing identification of the type of data for each of a plurality of data contained in the e-mail.

38. A storage medium according to claim 29, wherein said control software further comprises a control program for causing a subsequent process to be selectable from among a plurality of predetermined processes when it has been determined that the e-mail is not to be utilized.

39. A storage medium according to claim 29, wherein said control software further comprises a control program for identifying the type of data by analyzing the received e-mail.

40. A control program according to claim 29, wherein said control software further comprises a control program for retrieving a character string from the received e-mail, and identifying the type of data according to a character string specified based on a position in the received e-mail where the retrieved character string is present.
